(19) United States
(12) Patent Application Publication
(10) Pub. No.: US 2013/0091306 A1
(43) Pub. Date: Apr. 11, 2013

(54) Prompting Method of Message Update and Network Client Device

(71) Applicant: Tencent Technology (Shenzhen) Company Limited, Shenzhen (CN)

(72) Inventors: Heng Daunmu, Shenzhen (CN); Huateng Ma, Shenzhen (CN); Shiping Li, Shenzhen (CN)

(73) Assignee: TENCENT TECHNOLOGY (SHENZHEN) COMPANY LIMITED, Shenzhen (CN)

(21) Appl. No.: 13/686,711

(22) Filed: Nov. 27, 2012

Related U.S. Application Data
(63) Continuation of application No. PCT/CN2011/079625, filed on Sep. 14, 2011.

(30) Foreign Application Priority Data
Sep. 30, 2010 (CN) 201010510363.1

(51) Int. Cl. H04L 29/06

(52) U.S. Cl. CPC H04L 65/601
USPC 709/246

(57) ABSTRACT

Embodiments of the present invention provide a prompting method of message update and a network client device. The method includes: determining, by a client device, the number of update prompting symbols according to the number of updated messages provided by a server, and generates the update prompting symbols; and modifying, by the client device, state parameters of the update prompting symbols, and displaying the update prompting symbols according to the modified state parameters. Through the method and client device, the user can learn the number of updated messages according to the displayed update prompting symbols, so as to improve the network using experiences of the user.

### CROSS-REFERENCE TO RELATED APPLICATIONS

This application is a continuation of International Application No. PCT/CN2011/079625, filed on Sep. 14, 2011. This application claims the benefit and priority of Chinese Patent Application No. 201010510363.1, filed on Sep. 30, 2010. The entire disclosures of each of the above applications are incorporated herein by reference.

### FIELD OF THE INVENTION

The present invention relates to computer network technologies, and more particularly to a prompting method of message update and a network client device.

### BACKGROUND OF THE INVENTION

Micro-blogging is one kind of blog which allows a user to publish and update short characters (usually less than 200 characters) in time. When the micro-blogging is updated, for instance, when the user voluntarily requests for updating micro-blogging data in a server or the micro-blogging data is updated periodically by a program, an updated page pilot button displays an update prompting symbol (e.g., an air bubble), and the update prompting symbol flashes in a fadeout-fadein form through changing alpha values, so as to prompt the user that there is an updated message. The update prompting symbol flashes from rapidness to slowness and then to rapidness, and when the user views the updated message, the air buddle disappears.

FIG. 1 is a flowchart illustrating a prompting method of micro-blogging message update, which includes following processes.

Block 101, a server learns micro-blogging message update.

Block 102, the server notifies a client device of the micro-blogging message update.

Block 103, the client device updates state parameters of an air buddle.

Block 104, the client device displays the air buddle according to the updated state parameters, where the air buddle is displayed in a fadeout-fadein cartoon form.

However, the display effect of the update prompting symbol (e.g., the air bubble) is single, and the user is unable to obtain more information from the air bubble, for instance, the user is unable to learn the number of updated messages. Further, the visual effect of the air buddy is unsatisfied.

### SUMMARY OF THE INVENTION

Embodiments of the present invention provide a prompting method of message update and a network client device, so as to provide a more effective update prompt for a user.

The prompting method of message update includes:
determining, by a client device, the number of update prompting symbols according to the number of updated messages provided by a server, and generates the update prompting symbols; and
modifying, by the client device, state parameters of the update prompting symbols, and displaying the update prompting symbols according to the modified state parameters.

The network client device includes:
an updating unit, configured to receive the number of updated messages from a server, and provide the number of updated messages to a prompt symbol managing unit; and
the prompt symbol managing unit, configured to generate update prompting symbols according to the number of updated messages and a predefined mapping rule, modify state parameters of update prompting symbols, and display the update prompting symbols according to the modified state parameters, where the number of update prompting symbols corresponds to the number of updated messages.

In the method and network client device provided by the embodiments of the present invention, the number of the generated update prompting symbols is determined according to the number of updated messages, so that the user can learn the number of updated messages according to the number of the displayed update prompting symbols. In this way, a more effective update prompt may be provided for the user, so as to improve the network using experiences of the user. Further, through changing one or more parameters of the update prompting symbols, such as a movement track, alpha values and RGB (Red Green Blue) color, the embodiments of the present invention can greatly improve the display effect of the update prompt.

### BRIEF DESCRIPTION OF THE DRAWINGS

FIG. 1 is a flowchart illustrating a conventional prompting method of micro-blogging message update.

FIG. 2 is a flowchart illustrating a prompting method of message update according to an embodiment of the present invention.

FIG. 3 is a schematic diagram illustrating an internal structure of prompt symbol managing unit in a network client device according to an embodiment of the present invention.

FIG. 4 is a working flowchart of a state parameter configuring module according to an embodiment of the present invention.

FIG. 5a is a schematic diagram illustrating a movement track of air bubble according to an embodiment of the present invention.

FIG. 5b is a schematic diagram illustrating the curve of alpha values according to an embodiment of the present invention.

### DETAILED DESCRIPTION OF THE INVENTION

In order to make the object, technical solution and merits of the present invention clearer, the present invention will be illustrated in detail hereinafter with reference to the accompanying drawings and specific embodiments.

An embodiment of the present invention provides a prompting method of message update, which includes following processes.

A client device determines the number of update prompting symbols according to the number of updated messages provided by a server, generates the update prompting symbols and displays the generated update prompting symbols on the displayer of the client device, where the number of update prompting symbols corresponds to the number of updated messages. The client device modifies the state parameters of one or more update prompting symbols, and displays the update prompting symbols according to the modified state parameters. The messages may be communication messages such as micro-blogging messages or Instant Messaging (IM) messages which are transmitted through network hardware devices of Ethernet, radio communication network or core network.

It should be noted that the update prompting symbols mentioned in the embodiment of the present invention may be displayed on the displayer of the client device as round air bubbles, air bubbles with other shape, or patterns such as pictures or icons. The prompting method of message update provided by the embodiment of the present invention will be illustrated in detail hereinafter, in which it is supposed that the update prompting symbols are displayed as air bubbles. The update prompting symbols may also be displayed as other patterns, and the procedure of prompting the message update through other patterns are similar to that of prompting the message update through the air bubbles.

FIG. 2 is a flowchart illustrating a prompting method of message update according to an embodiment of the present invention.

Block 201, a server provides the number of updated messages to a client device through Ethernet or another communication network.

Block 202, the client device generates air bubbles according to the number of updated messages, where the number of air bubbles corresponds to the number of updated messages.

In block 202, the client device determines the number of to-be-generated air bubbles according to the number of updated messages provided by the server. Specifically, the client device may generate one air bubble for each updated message, i.e., the updated messages correspond to the air bubbles one by one. Of cause, the client device may generate the air bubbles according to a mapping rule. For example, suppose there are one to five updated messages, the number of to-be-generated air bubbles is equal to the predefined number of air bubbles in a first level (for instance, two air bubbles are generated), and suppose there are five to ten updated messages, the number of to-be-generated air bubbles is equal to the predefined number of air bubbles in a second level (for instance, four air bubbles are generated), where each level corresponds to the predefined number of updated messages. In this way, the user is able to learn the number of updated messages to some degree. It should be noted that, the mapping rule reflecting the corresponding relation between the number of updated messages and the number of air bubbles may be defined flexibly, which is not illustrated herein in detail.

In order to realize the effect of multiple air bubbles, an air bubble queue may be created on the client device, and is used for storing the generated air bubbles and the state parameters of each air bubble. The state parameters of each air bubble includes one or more of the location of the air bubble in the last time interval, track parameters, movement speed, alpha values and color parameters (e.g., RGB color).

Block 203, the client device modifies the state parameters of each air bubble at each time interval according to predefined interaction logics.

In this process, the client device configures and updates the state parameters of each air bubble through the interaction logics, e.g., configures and updates one or more of the current location, alpha values and RGB color of each air bubble, so as to achieve the effect of interaction animation.

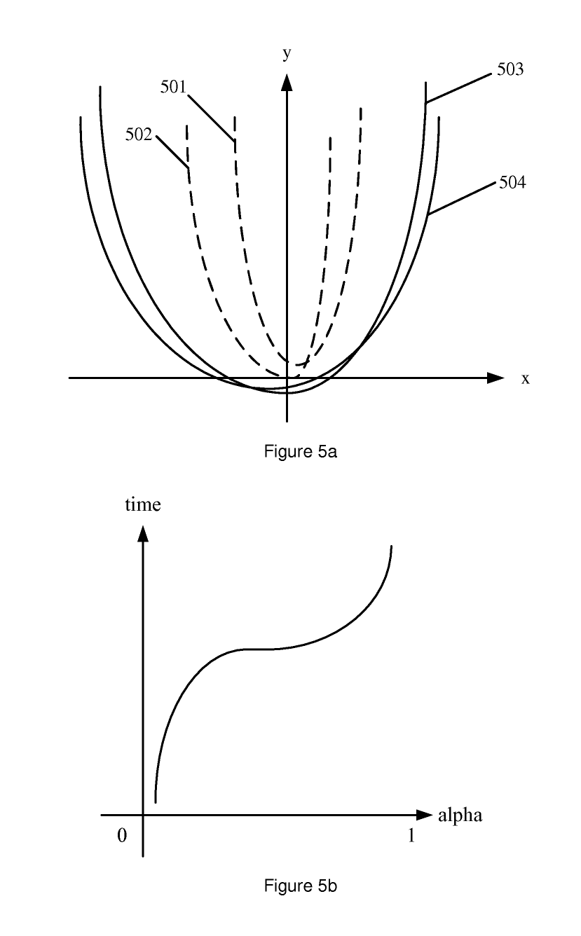

It should be noted that, the movement track of each air bubble is generated randomly, and the overall style of the air bubble may be smart or gentle according to different conditions. When the overall style of the air bubble is smart, both ends of the curve converges to the middle, and when the overall style of the air bubble is gentle, both ends of the curve diverges towards to the outside. In a specific implementation, the larger the number of updated messages is, the more convergent the movement direction of the air bubble is, and the smarter the movement speed of the air buddle is. At this time, the shape of the air bubble is similar to skyrocket. The dashed lines in FIG. 5a show the smart tracks 501 and 502 of the air bubble. The smaller the number of updated messages is, the more divergent the movement direction of the air bubble is, and the slower the movement speed of the air buddle is. The real lines in FIG. 5a show the gentle tracks 503 and 504 of the air bubble.

Further, whether the movement track of the air bubble is smart or gentle may be determined according to message update time of the server and/or message importance degree. When the updated message is from a buddy of the user or is a message published by a system, the movement track of the air bubble is smarter. When the updated message is a daily updated message or is a message from other users, the movement track of the air bubble is gentle. In a specific implementation, the movement track of the air bubble may be determined according to a weight sum method. Suppose there are three messages, the messages are given with different weight values according to the update time and message type of each message. For example, a message updated within one day is given with a weight value equal to 3, a message updated within 2 to 5 days is given with a weight value equal to 2, and a message updated over 5 days is given with a weight value equal to 1. A message sent by the system and buddies is given a weight value equal to 3, and a message sent by a stranger is given a weight value equal to 1. The weight values of the three messages are added to obtain a value, and the value is used to determine whether the movement track of the air buddle is smart or gentle.

Specifically, suppose x direction location of an air bubble t is (t.x), y direction location is (t.y), x direction speed is (t.speed_x), y direction speed is (t.speed_y) and x direction acceleration is (t.a_x), and suppose at the beginning, (t.x, t.y) is configured as (0, 0), t.speed_x is configured as 10, t.speed_y is configured as 10, and t.a_x is configured as −1, the movement track preset for the air bubble t may be updated at each time interval according to following formulas (1)-(3).

t.x=t.x+t.speed_x; (1)

t.y=t.y+t.speed_y; (2)

t.speed_x=t.speed_x+t.a_x. (3)

In formula (1), the t.x at the left side of the equation is the value of the current time interval, the t.x at the right side of the equation is the value of the last time interval, and the t.speed_x at the right side of the equation is the value of the current time interval. Similarly, in formula (2), the t.y at the left side of the equation is the value of the current time interval, the t.y at the right side of the equation is the value of the last time interval. In formula (3), the t.speed_x at the left side of the equation is the value of the next time interval, and the t.speed_x at the right side of the equation is the value of the current time interval. Since t.a_x is minus, the movement speed of the air bubble t at the x direction is also minus, and the movement direction of the air bubble t is changed from the right-upper direction into left-upper direction, so as to complete an arc track, as shown in FIG. 5a. As can be seen, according to the preset movement track, the current location of the air bubble at each time interval and the movement speed of the air bubble at the next time interval may be obtained, so as to form an animation through frame-to-frame circulation. It should be noted that, the larger the weight value which is determined according to one or more of the number of updated messages, message update time and message importance degree is, the larger the initial value of one or more of t.speed_x, t.speed_y and t.a_x is configured, and the smarter the movement track of the air bubble is.

For the curve of the alpha values, the parameters of Bessel curve may be customized, so as to obtain the best displaying effect. For example, a conventional ease-in-out curve may be used. The ease-in function is a Bessel curve (0.42, 0, 1.0, 1.0), the ease-out function is a Bessel curve (0, 0, 0.58, 1.0) and the ease-in-out function is a Bessel curve (0.42, 0, 0.58, 1.0). Of cause, the parameters of the curve may be configured as (0.43, 0, 0.54, 1.0). In a specific implementation, the curve of alpha values may be a Bessel curve shown in FIG. 5b.

The RGB color of the air bubble may be adjusted according to the smart degree of the movement of air bubble. The smarter the movement of the air bubble is, the more the RGB color closes to warm color, and the gentler the movement of the air bubble is, the more the RGB color closes to cold color, so as to obtain an obvious visual contrast effect. In addition, the RGB color of the air bubble may be adjusted according to a background color, so as to make the RGB color of the air bubble different from the background color.

Block 204, at the current time interval, the client device displays each air bubble according to the modified state parameters.

Block 205, it is determined whether an updated message is viewed; if yes, block 206 is performed; otherwise, block 203 is performed, i.e., modify the state parameters at the next time interval.

Block 206, the number of updated messages is modified according to the number of the viewed messages, and one or more air bubbles are cleared. If all air bubbles are cleared, the update prompting procedure terminates.

In another specific implementation, the above blocks 205 and 206 may be replaced with following processes.

Block 205′, it is determined whether all the updated messages are viewed; if yes, all air bubbles in the air bubble queue are cleared, and the update prompting procedure terminates; otherwise, block 206′ is performed.

Block 206′, the number of updated messages is modified according to the number of the viewed messages, one or more air bubbles are cleared, and block 203 is performed, i.e., modify the state parameters at the next time interval.

An embodiment of the present invention also provides a network client device, which includes:
an updating unit, configured to receive the number of updated messages from a server, and provide the number of updated messages to a prompt symbol managing unit; the prompt symbol managing unit, configured to generate update prompting symbols according to the number of updated messages and a predefined mapping rule, modify the state parameters of each update prompting symbol, and display the update prompting symbol according to the modified state parameters, where the number of the generated update prompting symbols corresponds to the number of updated messages. It should be noted that, the network client device may be a micro-blogging client device or an IM client device.

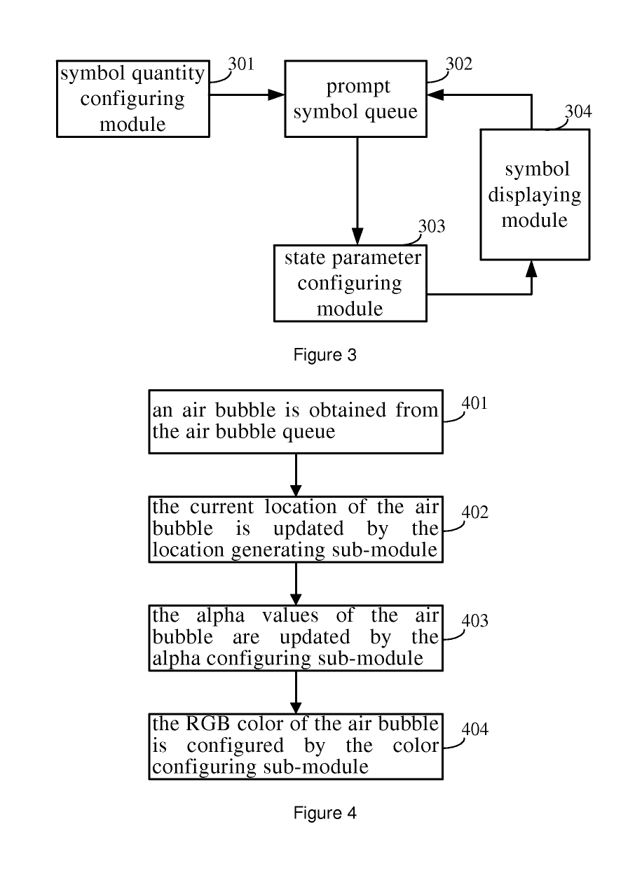

FIG. 3 is a schematic diagram illustrating an internal structure of a prompt symbol managing unit in a network client device according to an embodiment of the present invention. The prompt symbol managing unit includes a symbol quantity configuring module 301, a prompt symbol queue 302, a state parameter configuring module 303 and a symbol displaying module 304.

The symbol quantity configuring module 301 is configured to generate update prompting symbols according to the number of updated messages and a predefined mapping rule, and store the update prompting symbols in the prompt symbol queue 302, where the number of update prompting symbols corresponds to the number of updated messages.

The state parameter configuring module 303 is configured to modify the state parameters of one or more update prompting symbols in the prompt symbol queue at each time interval.

The symbol displaying module 304 is configured to display the update prompting symbols at each time interval according to the state parameters modified by the state parameter configuring module 303.

Specifically, the state parameter configuring module 303 includes at least one of location generating sub-module, alpha configuring sub-module and color configuring sub-module. The location generating sub-module is configured to modify the current location of the update prompting symbols at each time interval according to a predefined movement track, and further modify the movement speed of the update prompting symbols. The alpha configuring sub-module is configured to modify the alpha values of the update prompting symbols according to a predefined Bessel curve. The color configuring sub-module is configured to set the color parameters of the update prompting symbols at each time interval.

For an example that the update prompting symbols are air bubbles, FIG. 4 shows a working flowchart of the state parameter configuring module 303 according to an embodiment of the present invention. The working flowchart includes following processes.

Block 401, an air bubble is obtained from the air bubble queue.

Block 402, the current location of the air bubble is updated by the location generating sub-module. Further, the location generating sub-module updates the movement speed of the air bubble at the next time interval.

Block 403, the alpha values of the air bubble are updated by the alpha configuring sub-module.

In block 404, the RGB color of the air bubble is configured by the color configuring sub-module.

In FIG. 4, the sequence of performing blocks 402, 403 and 404 is not limited. Not all blocks 402, 403 and 404 are needed to be performed, and at least one of blocks 402, 403 and 404 may be performed.

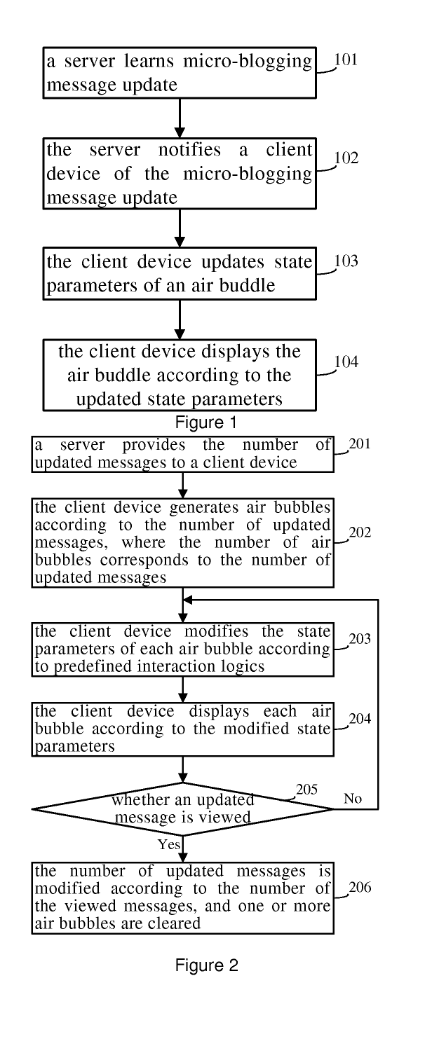

It should be noted that, in a specific implementation, the server is a computer hardware device, the network client device is a hardware device such as a mobile telephone or a mobile terminal device of other type, or is a software program installed on a hardware device. The mobile terminal device is composed of physical hardware modules including a communication interface, a displayer, storage and a processor. The communication interface is configured to receive information (e.g., the number of updated messages) sent by the server from an external network. The storage is configured to provide an actual physical storage space for storing information such as the number of updated messages and state parameters. The displayer is configured to display the update prompting symbols, where the number of the update prompting symbols corresponds to the number of updated messages. The processor is configured to perform the message update prompting procedure on the client device, referring to FIGS. 1, 2 and 4. The method provided by the embodiment of the present invention is single, and thus is applicable to mobile terminal devices whose storage and processing capability is much lower than that of general computers.

The foregoing is only preferred embodiments of the present invention and is not used to limit the protection scope of the present invention. Any modification, equivalent substitution and improvement without departing from the spirit and principle of the present invention are within the protection scope of the present invention.

What is claimed is:

1. A prompting method of message update, comprising:
determining, by a client device, the number of update prompting symbols according to the number of updated messages provided by a server, and generates the update prompting symbols; and
modifying, by the client device, state parameters of the update prompting symbols, and displaying the update prompting symbols according to the modified state parameters.

2. The method of claim 1, wherein the determining, by the client device, the number of update prompting symbols according to the number of updated messages provided by the server comprises one of:
setting one update prompting symbol for each updated message; and setting a mapping rule between the number of updated messages and the number of update prompting symbols, and determining the number of update prompting symbols according to the mapping rule.

3. The method of claim 1, wherein the modifying, by the client device, the state parameters of update prompting symbols comprises: modifying the current location of update prompting symbol at each time interval according to a predefined movement track.

4. The method of claim 3, wherein the movement track is predefined according to at least one of the number of updated messages, message update time and message importance degree.

5. The method of claim 1, wherein the modifying, by the client device, the state parameters of update prompting symbols comprises: modifying alpha values of update prompting symbols at each time interval according to a predefined Bessel curve.

6. The method of claim 1, wherein the modifying, by the client device, the state parameters of update prompting symbols comprises: configuring the RGB color of update prompting symbols at each time interval.

7. The method of claim 1, further comprising: if one or more updated messages are viewed, modifying the number of updated messages according to the number of viewed messages, and clearing one or more update prompting symbols.

8. The method of claim 1, wherein the update prompting symbols are air bubbles or patterns.

9. A network client device, comprising:
an updating unit, configured to receive the number of updated messages from a server, and provide the number of updated messages to a prompt symbol managing unit; and
the prompt symbol managing unit, configured to generate update prompting symbols according to the number of updated messages and a predefined mapping rule, modify state parameters of update prompting symbols, and display the update prompting symbols according to the modified state parameters, where the number of update prompting symbols corresponds to the number of updated messages.

10. The client device of claim 9, wherein the prompt symbol managing unit comprises a symbol quantity configuring module, a prompt symbol queue, a state parameter configuring module and a symbol displaying module; wherein
the symbol quantity configuring module is configured to generate the update prompting symbols according to the number of updated messages and the predefined mapping rule, and store the update prompting symbols in the prompt symbol queue, wherein the number of update prompting symbols corresponds to the number of updated messages;
the state parameter configuring module is configured to modify the state parameters of update prompting symbols in the prompt symbol queue at each time interval; and
the symbol displaying module is configured to display the update prompting symbols at each time interval according to the state parameters modified by the state parameter configuring module.

11. The client device of claim 10, wherein the state parameter configuring module comprises a location generating sub-module, configured to modify the current location of update prompting symbols at each time interval according to a predefined movement track.

12. The client device of claim 10, wherein the state parameter configuring module comprises an alpha configuring sub-module, configured to modify alpha values of update prompting symbols according to a predefined Bessel curve.

13. The client device of claim 10, wherein the state parameter configuring module comprises a color configuring sub-module, configured to configure color parameters of update prompting symbols at each time interval.

14. The client device of claim 9 wherein the network client device is a mobile terminal device.
